(19) United States
(12) Patent Application Publication
(10) Pub. No.: US 2012/0275511 A1
(43) Pub. Date: Nov. 1, 2012

(54) SYSTEM AND METHOD FOR PROVIDING CONTENT AWARE VIDEO ADAPTATION

(75) Inventors: Mikhal Shemer, Berkeley, CA (US); Marco Paniconi, Campbell, CA (US)

(73) Assignee: GOOGLE INC., Mountain View, CA (US)

(21) Appl. No.: 13/097,267

(22) Filed: Apr. 29, 2011

(51) Int. Cl. H04N 7/12

(52) U.S. Cl. 375/240.02; 375/E07.126

(57) ABSTRACT

A method and system for providing content aware media adaptation are described. Aspects of the invention adaptively down-sample a source video to optimize the encoding process of the source video. The system and method extract content characteristics from the source video by sampling the source video, and then classify the video into one or more content classes based on the extracted characteristics. The content class of the video is used to determine one or more down-sampling settings for the source video. In some aspects, the down-sampling settings are derived by sampling a plurality of videos and determining optimal transitional rates for the plurality of videos. The sampled videos may be used to generate a decision boundary to classify whether a particular video is a good candidate for spatial down-sampling.

### BACKGROUND

Increased access to high speed computer networks has led to an explosion in multimedia content available to users. In the course of a typical browsing session, the user may view images, listen to audio, and watch video. Each of these media types may be provided in various encoding formats to optimize the viewing experience for the user. Some content is provided in multiple formats, such that a user can select the most appropriate for their individual situation. For example, a video may be provided in both high definition (HD) and standard definition (SD) formats. A user with a slower connection may opt to view the video in SD format to reduce the delay while waiting for the video to load.

However, not all such decisions are straightforward. Different video formats and encoding methods may be optimal for some media, but not others, based on the content of the media. Network conditions and encoder performance may fluctuate, resulting in a particular format being optimal some times, but not others. A user may not be sophisticated enough to select an appropriate format for their system capabilities.

### BRIEF SUMMARY

Methods and systems for providing content aware video adaptation are described. Aspects of the invention adaptively modify video encoding settings using a preprocessor to optimize video spatial resolution and frame rate prior to encoding. Such optimization may be used to avoid coded picture buffer (CPB) overflow and to improve video quality. The systems and methods sample video content to determine various content characteristics of the video. The video is mapped into one or more content classes based on the identified content characteristics. The content class of the video is then used to down-sample the spatial and temporal resolution of the video where appropriate to optimize the encoding process, thus minimizing distortion and delay. Previously generated lookup tables, derived from off-line modeling of the content analysis of a video database, ensure efficient mapping of video content characteristics to optimal down-sampling and encoding settings. Use of lookup tables in this manner provides an efficient method for performing the analysis and decisions on the down-sampling settings such that the method and system are suitable for use in real-time applications.

One aspect of the disclosure provides a computer-implemented method for providing content aware video adaptation. The method includes sampling a source video, using a processor, to extract one or more content characteristics of the source video, classifying the source video into a content class based upon the extracted content characteristics, determining a spatial down-sampling setting for the source video based on the content class, and down-sampling the source video resolution using the determined spatial down-sampling setting to reduce distortion and delay during the encoding process. Determining the spatial down-sampling setting may further include plotting the extracted content characteristics on an n-dimensional plot and identifying the source video as a good candidate for spatial down-sampling based on the relationship of a plot of the extracted content characteristics with a decision boundary. Each of n axes of the n-dimensional plot may correspond to a content characteristic.

In some aspects, the method may further include identifying one or more normalized transitional rates using a lookup table indexed by the extracted content characteristics. Aspects of the method may also include identifying a representative cluster of video samples from video sample database and selecting one of a plurality of normalized transitional rates by identifying a normalized transitional rate associated with the representative cluster of video samples from a video sample database. A distortion function may be used to find the representative cluster. The representative cluster may be identified using a distortion function modeled by a weighted distance metric defined over a set of content features between the source video and a video sample from the representative cluster. A distortion function may be used to find the representative cluster. The video samples used in the distortion function may be conditioned on a content class and an image size. Aspects of the method may further include determining a spatial down-sampling setting by determining a transitional rate using the extracted content characteristics, and determining whether to perform spatial down-sampling based on whether an encoder rate is less than the transitional rate.

Aspects of the method may further include determining a spatial down-sampling mode. The spatial down-sampling mode may be determined by comparing an encoder rate to an identified transitional bit rate multiplied by a threshold. Aspects of the method may also include selecting 2×2 down-sampling as the spatial down-sampling mode in response to the encoder rate being less than the identified transitional bit rate multiplied by the threshold. Aspects of the method may further include selecting a spatial down-sampling mode based on one or more other content characteristics in response to the encoder rate being greater than or equal to the identified transitional bit rate multiplied by the threshold. In some aspects, depending upon the extracted content characteristics, a 2×2 down-sampling, 1×2 down-sampling, or 2×1 down-sampling mode may be selected. The extracted content characteristics may include at least one of a motion coherence or a motion horizontalness. One or more user preferences may be used to determine whether to perform spatial down-sampling.

In some aspects, the method further includes determining a temporal down-sampling setting for the source video based on the content class, and down-sampling the source video frame rate using the determined temporal down-sampling setting such that distortion and delay is minimized during the encoding process. The temporal down-sampling setting may be determined by a process including determining a motion level for the source video based on the extracted content characteristics, computing a temporal down-sampling rate for frame rate reduction based on a frame rate of the source video, a frame size of the source video, a normalized transitional rate associated with the source video, and the motion level, comparing the temporal down-sampling rate with an encoder rate, and reducing the frame rate of the source video in response to the encoder rate being less than the temporal down-sampling rate. In some aspects, the frame rate of the source video is reduced in accordance with the motion level. The method may further include comparing the frame rate of the source video with a threshold value, and reducing the frame rate in response to the frame rate being greater than the threshold value. The threshold value may be a user specified frame rate threshold.

In some aspects, of the method, the content characteristics are extracted at a regular interval. The content characteristics may be averaged at each interval over a set length of the video. In some aspects, the content characteristics associated with the video are at least one of a size of zero motion value, a motion prediction error value, a motion magnitude value, a motion horizontalness value, a motion distortion value, a normalized temporal difference value, and one or more spatial prediction errors associated with at least one spatial down-sampling mode.

Some aspects of the method further include tracking one or more encoder statistics, and down-sampling at least one of the spatial resolution or the temporal resolution in response to the encoder statistics dropping below a threshold value. The encoder statistics may include at least one of a percentage of skipped frames, a percentage rate mismatch, or an encoder buffer level. Aspects of the method may further include selecting at least one of a spatial down-sampling mode or a temporal down-sampling mode in response to the content characteristics of the source video.

Another aspect of the disclosure describes a computer-implemented method for identifying video candidates for spatial down-sampling. The method includes extracting, using a processor, one or more content characteristics from a plurality of videos, generating a video quality metric plot for each of the plurality of videos by plotting a distortion metric as a function of a video bit rate, extracting a transitional bit rate from the video quality metric plot for each of the plurality of videos, determining whether the extracted transitional bit rate for each video of the plurality of videos is greater than a threshold bit rate, generating an n-dimensional plot for the plurality of videos, and computing a decision boundary between a set of videos with extracted transitional bit rates greater than the threshold bit rate and a set of videos with extracted transitional bit rates less than the threshold bit rate. The video quality metric plot includes plotted distortion metrics for each video with a plurality of spatial down-sampling modes. The n-dimensional plot comprises n axes corresponding to content characteristics of the videos. Each video is plotted in accordance with its associated extracted content characteristics. Aspects of the method further include identifying one or more clusters of data points corresponding to videos with similar content characteristics, and storing the clusters within a data table indexed by the content characteristics. The data table may further include one or more normalized transitional rates associated with the clusters. The distortion metric may be a peak signal-to-noise ratio (PSNR) or a structural similarity (SSIM) metric. In some aspects, the decision boundary is an n−1 dimensional curve derived from a support vector machine trained on the content characteristics and spatial down-sampling candidacy of the plurality of videos. The n-dimensional plot may be a 2 dimensional plot with axes corresponding to a motion prediction error value and a spatial prediction error value.

Another aspect of the disclosure describes a processing system for providing content aware media adaptation. The processing system includes at least one processor, a preprocessor for sampling a source video and extracting one or more content characteristics, a content aware selector associated with the at least one processor and the preprocessor, and memory for storing a video database. The memory is coupled to the at least one processor. The preprocessor may be configured to sample a source video to extract one or more content characteristics of the source video. The content aware selector may be configured to classify the source video into a content class based on the content characteristics, determine a spatial down-sampling setting for the video, determine a temporal down-sampling setting for the video, and configure an encoder to encode the video in accordance with the spatial down-sampling setting and the temporal down-sampling setting. Aspects of the processing system may also include an encoder module to encode the source video in accordance with one or more settings received from the content aware selector. The content aware selector may further perform a lookup operation on the database to classify the source video. The database may be indexed by one or more content characteristics, and the lookup operation may provide a normalized transitional bit rate for the source video.

### BRIEF DESCRIPTION OF THE DRAWINGS

FIG. 1 is a system diagram in accordance with aspects of the invention.

FIG. 2 illustrates a method for providing content aware video adaptation in accordance with aspects of the invention.

FIG. 3 illustrates a method for determining spatial down-sampling settings based on video content in accordance with aspects of the invention.

FIG. 4 illustrates a method for generating a transitional bit rate lookup table in accordance with aspects of the invention.

FIG. 5 is an exemplary graph of a transitional bit rate for a sample video in accordance with aspects of the invention.

FIG. 6 is a graph of a down-sampling decision boundary in accordance with aspects of the invention.

FIG. 7 is a method for determining frame rate down-sampling in accordance with aspects of the invention.

FIG. 8 is a method for performing spatial down-sampling based on encoder statistics in accordance with aspects of the invention.

FIG. 9 is a block diagram of a system in accordance with aspects of the invention.

### DETAILED DESCRIPTION

Embodiments of systems and methods for providing adaptive media optimization are described herein. Aspects of the invention optimize the encoding and transmission of video content to minimize playback distortion and delay. Aspects of the invention adaptively down-sample a source video to optimize the encoding process of the source video. The system and method extract content characteristics from the source video by sampling the source video, and then classify the video into one or more content classes based on the extracted characteristics. The content class of the video is used to determine one or more down-sampling settings for the source video. In some aspects, the down-sampling settings are derived by sampling a plurality of videos and determining optimal transitional rates for the plurality of videos. The sampled videos may be used to generate a decision boundary to classify whether a particular video is a good candidate for spatial down-sampling.

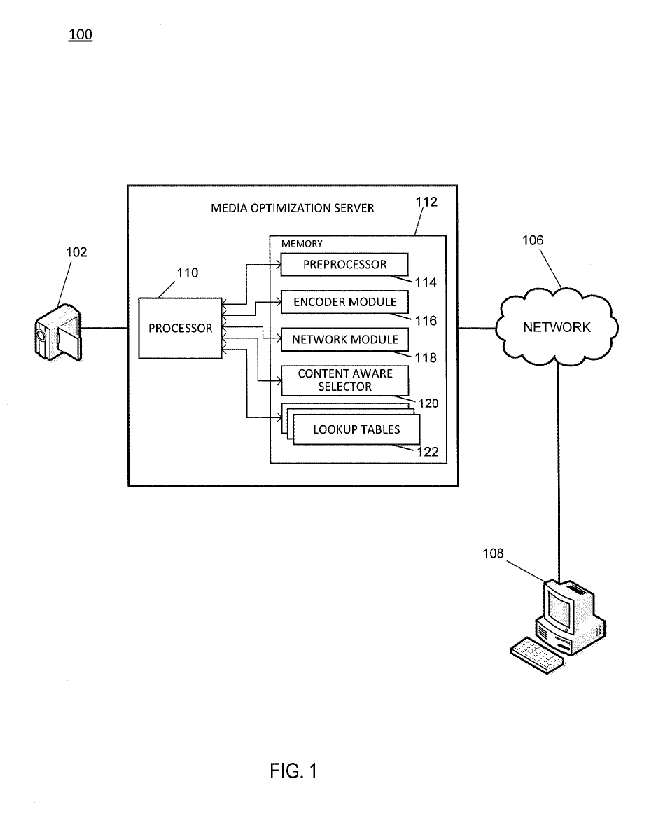

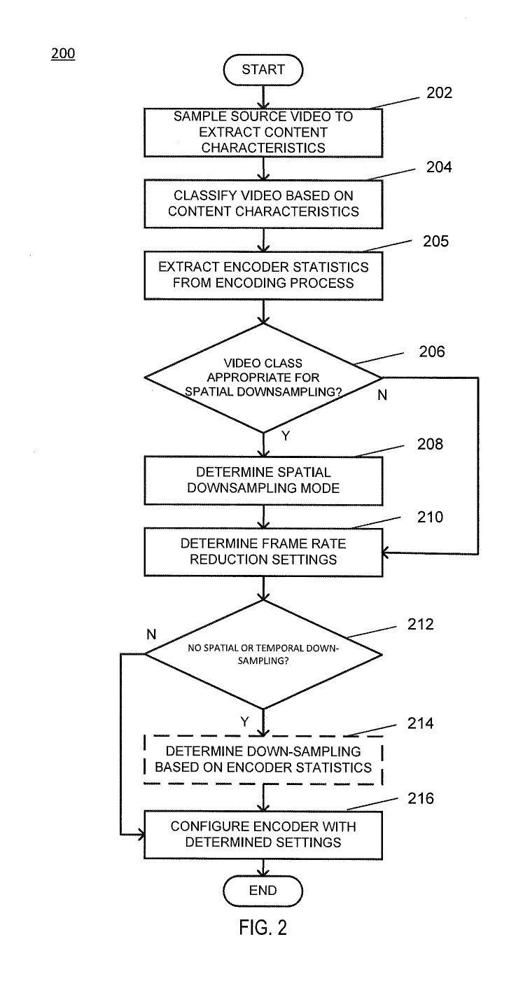

FIG. 1 is a system diagram depicting a server in communication with a video source and a client device in accordance with aspects of the invention. As shown in FIG. 1, a system 100 in accordance with one aspect of the invention includes a video source 102, a media optimization server 104, a network 106, and a client device 108. The media optimization server 104 receives video data from the video source 102, and encodes and transmits to the video to the client device 108 via the network 106. The encoding processes may be optimized based upon the content of the source video. An example of a process by which this optimization occurs is described below. (see FIG. 2).

The video source 102 may be any device capable of capturing or transmitting a video image. For example, the video source may be a digital camera, a digital camcorder, a computer server, a webcam, a mobile phone, a personal digital assistant, or any other device capable of capturing or transmitting video. In some aspects, the media optimization server 104 may receive audio and/or video from multiple video sources 102, and combine the sources into a single stream.

The media optimization server 104 may include a processor 110, a memory 112 and other components typically present in general purpose computers. The memory 112 may store instructions and data that are accessible by the processor 110. The processor 110 may execute the instructions and access the data to control the operations of the media optimization server 104.

The memory 112 may be any type of memory operative to store information accessible by the processor 110, including a computer-readable medium, or other medium that stores data that may be read with the aid of an electronic device, such as a hard-drive, memory card, read-only memory (“ROM”), random access memory (“RAM”), digital versatile disc (“DVD”) or other optical disks, as well as other write-capable and read-only memories. The system and method may include different combinations of the foregoing, whereby different portions of the instructions and data are stored on different types of media.

The instructions may be any set of instructions to be executed directly (such as machine code) or indirectly (such as scripts) by the processor 110. For example, the instructions may be stored as computer code on a tangible computer-readable medium. In that regard, the terms “instructions” and “programs” may be used interchangeably herein. The instructions may be stored in object code format for direct processing by the processor 110, or in any other computer language including scripts or collections of independent source code modules that are interpreted on demand or compiled in advance. Functions, methods and routines of the instructions are explained in more detail below (see FIGS. 2-8).

Data may be retrieved, stored or modified by processor in accordance with the instructions. For instance, although the architecture is not limited by any particular data structure, the data may be stored in computer registers, in a relational database as a table having a plurality of different fields and records, Extensible Markup Language (“XML”) documents or flat files. The data may also be formatted in any computer readable format such as, but not limited to, binary values or Unicode. By further way of example only, image data may be stored as bitmaps made up of grids of pixels that are stored in accordance with formats that are compressed or uncompressed, lossless (e.g., BMP) or lossy (e.g., JPEG), and bitmap or vector-based (e.g., SVG), as well as computer instructions for drawing graphics. The data may include any information sufficient to identify the relevant information, such as numbers, descriptive text, proprietary codes, references to data stored in other areas of the same memory or different memories (including other network locations) or information that is used by a function to calculate the relevant data.

The processor 110 may be any well-known processor, such as processors from Intel Corporation or AMD. Alternatively, the processor may be a dedicated controller such as an application-specific integrated circuit (ASIC). The processor may also be a programmable logic device (PLD) such as a field programmable logic device (FPGA).

Although FIG. 1 functionally illustrates the processor and memory as each being within a single block, it should be understood that the processor 110 and memory 112 may actually include multiple processors and memories that may or may not be stored within the same physical housing. Accordingly, references to a processor, computer or memory will be understood to include references to a collection of processors, computers or memories that may or may not operate in parallel.

The media optimization server 104 may be at one node of a network and be operative to directly and indirectly communicates with other nodes of the network. For example, the media optimization server 104 may include a web server that is operative to communicate with client device via the network such that the media optimization server 104 uses the network to transmit and display information to a user on a display of the client device. While the concepts described herein are generally discussed with respect to a media optimization server 104, aspects of the invention can also be applied to any computing node capable of managing media encoding operations.

Preferably, the system provides privacy protections for the client data including, for example, anonymization of personally identifiable information, aggregation of data, filtering of sensitive information, encryption, hashing or filtering of sensitive information to remove personal attributes, time limitations on storage of information, and/or limitations on data use or sharing. Preferably, data is anonymized and aggregated such that individual client data is not revealed.

In order to facilitate the media optimization operations of the media optimization server 104, the memory 112 may further include a preprocessor 114, an encoder module 116, a network module 118, a content aware selector 120, and a set of lookup tables 122.

The preprocessor 114 receives incoming data from the video source 102. For example, the preprocessor 114 may be a driver application interfacing with a webcam device, a server application receiving data from a client device transmitting a video stream, an application receiving an encoded video file from a remote source, and the like. The preprocessor 114 operates to accept the data from the video source and send a sample of the video data to the content aware selector 120. The preprocessor 114 also performs content analysis and resolution reduction operations in accordance with the content aware selector 120. In some aspects, the content analysis includes coarse motion estimation and motion features computation to determine one or more motion features of a video, and spatial feature computation to determine one or more spatial features of a video. The preprocessor 114 may reduce the resolution of the video in accordance with instructions received from the content aware selector 120 in order to optimize the video for encoding by the encoder module 116. The preprocessor 114 may be implemented as either hardware or software, or some combination thereof. In some aspects, the preprocessor 114 is implemented as an application specific interface circuit (ASIC).

The encoder module 116 manages the process by which the video received via the preprocessor 114 is processed into a format suitable for packetization and transmission by the network module 118. The encoder module 116 receives instructions from the content aware selector 120 to configure the encoding operations, such as the format, the frame rate, the spatial resolution, and the Error Resilience (ER) settings associated with the video. For example, one such encoder ER feature forces intra-coding for some macro-blocks on P-frames (delta frames). In such a case, the ER settings may determine the amount of macro-block encoding present on the P-frames. By encoding extra data into the P-frames, ER allows for the ability to recover in the event of errors (such as those caused by dropped or delayed packets) in one or more previous and/or subsequent frames.

The network module 118 manages the packetization and transmission of the video as encoded by the encoder module 116. The network module 118 receives instructions from the content aware selector 120 to configure the network parameters, such as the Forward Error Correction (FEC) protection/rate, and whether or not a negative acknowledgement character (NACK) method is used to verify that a packet has been received by a client device. FEC methods generally operate to send extra/redundant packets to enable the receiver to recover lost packets. A traditional NACK method operates by sending a notification to a sender whenever the receiver has failed to receive a data packet, either due to a timeout or receiving a next packet out of order. When the receiver sends such a notification (a NACK), the server retransmits the packet.

The content aware selector 120 manages the encoding, packetization, and transmission operations as performed by the encoder module 116 and the network module 118. The content aware selector 120 receives a sample of video data from the preprocessor 114 performs a content analysis on the video sample using content features extracted from the video and a set of lookup tables 122, and then instructs the encoder module 116 based on the content analysis and a set of encoder statistics. Methods by which this analysis may be performed are described below (see FIGS. 2-8).

The lookup tables 122 include a set of configuration parameters that are indexed by a set of video content characteristics. The lookup tables 122 are referenced by the content aware selector 120 to configure the settings of the encoder module 116. In some aspects, the content aware selector 120 accesses a video content class table to determine one or more transitional rates for a source video. Methods for accessing and generating these tables are described further below (see FIGS. 2-7).

The client device 108 is operable to store and/or display video content as received from the media optimization server 104. The client device 108 may be any device capable of managing data requests via the network 106. Examples of such client devices include a personal computer (PC), a mobile device, or a server. The client device 108 may also include a personal computer, a personal digital assistant (“PDA”), a tablet PC, a netbook, a smart phone, etc. Indeed, client devices in accordance with the systems and methods described herein may include any device operative to process instructions and transmit data to and from humans and other computers including general purpose computers, network computers lacking local storage capability, etc.

The network 106, and the intervening nodes between the media optimization server 104 and the client device 108 may include various configurations and use various protocols including the Internet, World Wide Web, intranets, virtual private networks, local Ethernet networks, private networks using communication protocols proprietary to one or more companies, cellular and wireless networks (e.g., Wi-Fi), instant messaging, hypertext transfer protocol (“HTTP”) and simple mail transfer protocol (“SMTP”), and various combinations of the foregoing. It should be appreciated that a typical system may include a large number of connected computers.

Although certain advantages are obtained when information is transmitted or received as noted above, other aspects of the system and method are not limited to any particular manner of transmission of information. For example, in some aspects, information may be sent via a medium such as an optical disk or portable drive. In other aspects, the information may be transmitted in a non-electronic format and manually entered into the system.

FIG. 2 is a method for providing content aware video adaptation in accordance with aspects of the invention. The method analyzes video content that is to be encoded. Depending upon one or more content characteristics identified within the video content, the video is spatially and/or temporally down-sampled as appropriate.

The term down-sampling generally applies to reducing the resolution and/or frame rate of a video. Down-sampling methods have the potential to improve the quality of the video at low bitrates by reducing the frame size or frame rate of the input video. Spatial down-sampling refers to the process by which content within a video frame is sampled at a smaller resolution than the original size. For example, a 2×2 block of pixels may be combined into a single 1×1 pixel. Temporal down-sampling refers to reducing the number of individual frames of the video such as, for example, skipping every other frame (frame rate reduction by two), or skipping every third frame (frame rate reduction by three).

In some aspects, the video may be down-sampled to conform to the requirements of the encoding process by an encoding module. However, introducing spatial down-sampling during the encoding process may introduce coding artifacts and distortion, such as blockiness and temporal degradation around moving objects due, for example, to the use of different spatial modes for different blocks. By conducting spatial down-sampling using a pre-processor (in other words, prior to the encoding of the video), the spatial resolution change is performed globally at the video sequence level. This approach preserves the syntax formation of the encoding codec, and may potentially have less visible artifacts than down-sampling the spatial resolution of the video frame locally (i.e., at macro-block level) during the encoding process.

At block 202 of the method 200, a source video is sampled to extract one or more content characteristics. The sampling process may be performed using a preprocessor, such as the preprocessor 114. The content characteristics may include, but are not limited to, motion features and spatial features.

The content characteristics for a given video frame at time t are denoted as Cᵢ(t), where I=1, 2, . . . m for m features. The features are updated (averaged) recursively over time:

Ĉᵢ(t)=αCᵢ(t)+(1−α)Ĉᵢ(t−1) (Eq. 1)

where Ĉᵢ(t) is the updated metric with smoothing parameter

$$α = \frac{1}{Tf}$$

where f is the encoder frame rate and T is a user-defined time interval, such as 5 seconds, 10 seconds, or the Group of Pictures (GOP) interval (the time between key frames). The features are averaged each interval, so as to provide overall values for the entire video. The end result of the feature characteristic extraction is a set of average content characteristics, Ĉ₁ . . . Ĉₘ, with each feature associated with the average for that feature over the course of the video, with the individual measurements used to form the average being of length T. Examples of the features used to characterize the scene content are defined herein. The frame/time index is omitted for simplicity of notation.

The motion features generally describe aspects of the video that relate to temporal changes that occur within the content of the video. Examples of the motion features include the size of zero motion, the amount of motion prediction error, the magnitude of motion, the horizontalness of motion, the amount of distortion in motion, and normalized temporal frame difference. In some aspects, the motion characteristics are determined on a spatial down-sampled image, such as an image down-sampled by a factor of 4 (2×2 decimation), or a factor of 16 (4×4 decimation). This is done to reduce the complexity of the motion feature extraction, though the method is also applicable to no spatial down-sampling for motion feature extraction. Some of the motion features are determined by extracting a motion vector for each block size (motion block) on the image, such as a block of 8×8 pixels. The values for N as described below refer to the number of these motion blocks. The method is also applicable to any size of the motion block, such as 16×16, 4×4, and the like.

The size of zero motion characteristic refers to a measurement of the stationarity of the video scene. The value of the size of zero motion is defined by the fraction of blocks within a sampled video that contain no motion. Such a value is represented by the function:

$${C}_{1} = 1 - \frac{{N}_{nz}}{N} \qquad ( Eq . 2 )$$

where N_{nz} is the number of blocks with a non-zero motion vector, and N is the total number of blocks.

The motion prediction error characteristic refers to the average prediction error over all motion blocks. The value of the motion prediction error characteristic is defined by the function:

$${C}_{2} = \frac{1}{N} {\sum }_{k} {e}_{k} \qquad ( Eq . 3 )$$

where N is the total number of blocks in the image, k is the particular motion block being analyzed, and eₖ is the prediction error associated with the motion vector of the block k.

The motion magnitude value measures the average amount of motion over the moving regions of the images (i.e. over the non-zero motion vectors). The motion magnitude value is defined by the function:

$${C}_{3} = \frac{1}{{LN}_{nz}} {\sum }_{k} \vert {v}_{k} \vert \qquad ( Eq . 4 )$$

where L is a length factor for normalizing the motion feature relative to the frame width, and vₖ is the motion vector for the block k.

The motion horizontalness feature measures the degree of horizontal motion in the sampled video. This feature is useful as more spatial detail is generally more noticeable along the horizontal direction than the vertical. The horizontalness value is extracted over all non-zero motion vectors. The horizontalness value is defined by the function:

$${C}_{4} = \frac{1}{{N}_{nz}} {\sum }_{k ∈ nz} ( \frac{\vert {v}_{k}^{x} \vert}{\vert {v}_{k} \vert} ) \qquad ( Eq . 5 )$$

where V^{x} is the magnitude of the horizontal motion of the motion vector associated with the block k.

The motion distortion feature may be defined as the average magnitude difference vector, normalized by the motion magnitude. A function to define the motion distortion value may be:

$${C}_{5} = \frac{1}{{C}_{3} {N}_{nz}} {\sum }_{k ∈ nz} \vert \vec{{v}_{k}} - 〈 \vec{{v}_{k}} 〉 \vert \qquad ( Eq . 6 )$$

where [symbol] \vec{vₖ} [symbol] is defined as the average over all non-zero motion blocks.

For the last three quantities defined above, C₃, C₄, C₅, a threshold is applied to ignore the features if the number of non-zero motion vectors for that frame is too small, to avoid spurious large fluctuations.

The normalized temporal frame difference (NFD) is a generalized value which reflects the overall motion level of the scene. This feature samples the pixel data of the current and previous frame to measure the amount of motion. A function for defining the NFD is:

$$NFD = \frac{1}{σ} 〈 \vert I ( i , j , t ) - I ( i , j , t - 1 ) \vert 〉 \qquad ( Eq . 7 )$$

where I(i, j, t) is the luminance level at pixel (i, j) at frame t, t−1 represents the previous frame, and σ is the signal variance level for frame t, such that σ=\sqrt{ [symbol]I² [symbol]}. The [symbol] indicates that the average of all pixels in the image should be taken.

The spatial features of the sampled video are derived directly from the frames input to the encoder. The spatial features measure the degree of local spatial activity in the scene. Three spatial features, corresponding to the spatial down-sampling (decimation) modes of 2×2, 1×2, and 2×1 are defined as:

$$( 2 x 2 ) {C}_{6} = \frac{1}{σ} {\sum }_{( i , j ) ∈ {N}_{r}} \vert I ( i , j ) - 0.25 * ( I ( i , j + 1 ) + I ( i + 1 , j ) + I ( i , j - 1 ) + I ( i + 1 , j ) + I ( i - 1 , J ) ) \vert \\ ( 1 x 2 ) {C}_{7} = \frac{1}{σ} {\sum }_{( i , j ) ∈ {N}_{r}} \vert I ( i , j ) - 0.5 * ( I ( i , j + 1 ) + I ( i , j - 1 ) ) \vert \\ ( 2 x 1 ) {C}_{8} = \frac{1}{σ} {\sum }_{( i , j ) ∈ {N}_{r}} \vert I ( i , j ) - 0.5 * ( I ( i + 1 , j ) + I ( i - 1 , J ) ) \vert \qquad ( Eq . 8 )$$

where I(i, j) is the image luminance level at pixel location (i, j). The spatial prediction errors may be computed on the input frame using a reduced set of pixels, Nᵣ to reduce complexity, such as, for example, one fourth of the total pixels, one half of the total pixels, or one third of the total pixels. In one aspect the image level, I(i, j), is the luminance signal, though it may also refer to color components signals as well. The signal variance σ=\sqrt{ [symbol]I² [symbol]} is used as a normalization factor. The spatial features provide an estimate of the up-sampling prediction error for 2×2, 1×2, and/or 2×1 decimation. Although 2×2, 1×2, and/or 2×1 decimation are provided as examples, other decimation methods such as 1.5×1.5, 2×4, 4×4, and the like could also be used.

The content characteristics defined above are extracted from the video input to the encoder, at the encoder resolution. In cases where the encoder resolution is different from the native resolution, such as because of a prior down-sampling decision, the spatial and motion features are computed for both the encoder resolution and the native resolution. In another case, to reduce complexity, the spatial features may be computed for both the encoder resolution and the native resolution, while the motion features may be computed from the encoder resolution and then used to estimate the motion features for the native resolution. In such a case, two sets of features are obtained, a set for the native resolution and a set for the encoder resolution. The native resolution may be used for decision making on returning to the native resolution, and the encoder resolution used for decisions on further resolution reduction.

At block 204, the video is classified based upon the extracted content characteristics. Different classes of video are associated with different content characteristics. For example, a video may be classified into a particular motion level class, or a particular motion coherency class. The motion level class is determined by first calculating the motion level, and then comparing the calculated motion level to a set of threshold values. For example, the motion level may be defined as ML=(1−Ĉ₁)Ĉ₃. This value refers to the amount of overall motion in the screen (1−the size of zero motion value) multiplied by the magnitude of the motion. The motion coherence level is defined as

$$MC = \frac{{\hat{C}}_{4}}{{\hat{C}}_{5}} ,$$

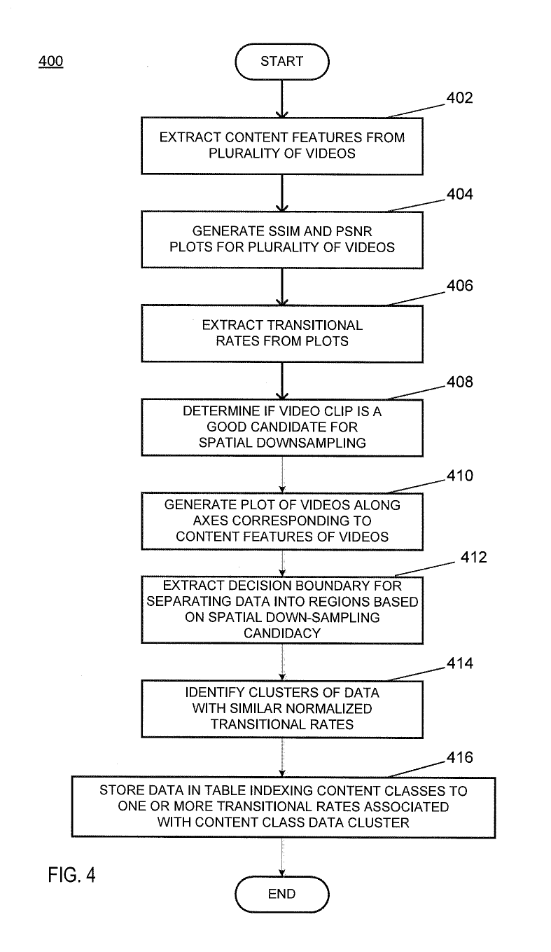

using a ratio of the distortion to the horizontalness of the motion. The calculated values are then used to classify the motion level and motion coherence level. For example, a motion level of at least 0.5 but less than 1.5 may fall into motion level category 1, and a motion level of greater than 1.5 may fall into a motion level category of 2. Depending upon the feature and the method used to determine the categories, different values might be used, such as motion category 1 being defined by a motion level of at least 2.1, or a motion category of 0 being defined as a motion level of less than 1.2. A method for determining a set of content characteristic thresholds is described further below (see FIG. 4).

One of the content classes into which the video may fall is the spatial down-sampling content class. This content class determines whether the video is a good candidate for spatial down-sampling as described above. If the video falls into this content class, then the video will exhibit a reduction in overall distortion if down-sampled prior to encoding below a particular bit rate. The process for defining the spatial down-sampling class is described further below (see FIG. 4). The spatial down-sampling class is denoted as SD=1 (favorable to spatial down-sampling), or SD=0 (not favorable).

The content classes are used to extract a normalized transitional rate from a table lookup operation. The table lookup operation determines a representative normalized transitional rate associated with content of the source video. The representative normalized transitional rate is used to determine if the source video should be spatially down-sampled prior to encoding. In cases where the source video is classified as a good candidate for spatial down-sampling (SD=1), the lookup table may provide multiple potential transitional bit rates. Each of these normalized rates is associated with a cluster of video samples from the database described with respect to FIG. 4. The optimal transitional bit rate is determined by identifying the appropriate cluster for the source video. This process is done using a distortion metric to quantify the distance between the source video and a video sample from the database. In one aspect, the distortion is defined using motion level (ML), the motion coherence (MC), the motion prediction error, and the spatial prediction error, features. The distance between the source video and the representative video sample is modeled by the function:

Dₖ=w₁|MLₖ−MLₓ|+w₂|Ĉ₆ₖ−Ĉ₆ₓ|+w₃|Ĉ₂ₖ−Ĉ₂ₓ|+w₄|MCₖ−MCₓ| (Eq. 9)

where x denotes the input video, and k denotes a video sample index from the database that belongs to the SD=1 class. In another method, the index k denotes a video sample index from the database that has the class SD=1 and has the same image size as source video. The distortion function is minimized over all the considered video samples k, and the sample k with smallest distortion is selected. The source video may then use the normalized transitional rate corresponding to that cluster of the selected video sample. The weight factors, w₁ . . . w₄ in the distortion function may be fixed or determined during processing time depending upon the individual content characteristics.

To determine the estimated transitional bit rate for the video, the representative normalized rate must be multiplied by the frame rate and the size of the frame image. Thus the function for determining the estimated transitional bit rate is Rᵢᵣ=Nf\tilde{r}, where N is the size of a frame of the source video, f is the frame rate of the source video, and \tilde{r} is the normalized rate as determined in the table lookup operation. In some aspects, a further correction term is applied to determine \tilde{r}, such as by the function

\tilde{r}= [symbol] rᵢᵣ [symbol] ᵢ+εᵢ(ML,Ĉ₆) (Eq. 10)

where [symbol] rᵢᵣ [symbol] ᵢ is the representative normalized rate from the lookup table and εᵢ is a correction term. The correction term may bias the estimate depending on the motion and spatial levels of the source video. In another aspect the correction term may come from a rate-distortion model.

The classification of the video determines whether the video is a good candidate for spatial down-sampling. This calculation is performed by comparing the average actual encoding rate with the estimated transitional rate. If the average actual encoding rate is higher than the estimated transitional rate, no spatial down-sampling is appropriate. If the average actual encoding rate is lower than the estimated transitional rate, then spatial down-sampling prior to encoding will likely result in a reduction in compression artifacts, and the video is therefore a good candidate for spatial down-sampling. In some aspects, a shift factor is applied to the estimated transitional bit rate to bias the spatial resolution preference. A positive shift factor increases the estimated transitional rate and results in a bias towards down-sampling, while a negative shift factor decreases the estimated transitional rate and results in a bias towards frame rate reduction. In some aspects, the bias factor may be configured based on user settings.

At step 205, statistics are extracted from the encoder, such as the maximum or average actual encoding bit rate, encoder buffer level, and number of skipped frames. These statistics are used in concert with the video content characteristics to determine if the video is a candidate for down-sampling. The method branches at block 206 based upon whether the video is a good candidate for spatial down-sampling, based on the source content and encoding rate. For example, if the transitional bit rate associated with the video source content is above the average or maximum encoding bit rate, or above a certain threshold of the average or maximum encoding rate, then the video is considered a candidate for spatial down-sampling. If the video is a candidate for spatial down-sampling, the method 200 proceeds to block 208 where the spatial down-sampling mode is determined. Otherwise, the method 200 proceeds to block 210 where the temporal down-sampling mode is determined.

At block 208, an appropriate spatial down-sampling mode is determined based on the content characteristics. For example, the spatial down-sampling mode may be decided based upon the spatial features (prediction error) and the motion coherence. For example, 2×2 down-sampling (wherein a square 2 pixels on a side is converted to a single pixel) is typically selected at lower rates, such as below some fraction of the estimated transitional rate. The fraction may be an arbitrary fraction as defined by the system, such as one half, one quarter, or one third of the transitional rate. In some aspects, the fraction is specified by a user as part of a set of user preferences. Otherwise, a spatial down-sampling mode corresponding to the lowest spatial prediction error (C₇ for 1×2, C₈ for 2×1, as described above) is selected.

A threshold value for videos with low levels of motion coherence (MC), a high degree of motion horizontalness (C₆) or a low level of spatial prediction error for 2×2 down-sampling (C₈) may be used to determine if the scene is optimal for 2×2 down-sampling using the function:

Ĉ₇<Ĉ₆−T₁(MC,Ĉ₄)

Ĉ₈<Ĉ₆−T₂(MC,Ĉ₄) (Eq. 11)

where Ĉ₇,Ĉ₈ is the spatial prediction error for 1×2 and 2×1 modes. The two thresholds, T₁,T₂, are for the cases of horizontal (1×2) and vertical (2×1) decimation, respectively. The thresholds are functions of the motion coherence and horizontalness. If equation (11) above is satisfied for one of the modes, that is, if one of the spatial prediction errors for the 1×2, or 2×1 mode is lower than the spatial prediction error for the 2×2 mode by the amount given by the threshold, then that spatial mode is selected. If both spatial modes satisfy equation (11), then the smaller of Ĉ₇,Ĉ₈ and the corresponding spatial mode is selected. Otherwise, if equation (11) is not satisfied by the 1×2, or 2×1 modes, then the 2×2 mode is selected. Establishing a threshold as a function of the motion coherence and motion horizontalness in this manner allow a bias based on different content characteristics. For example, content with a lower motion coherence generally means higher coding complexity, and hence a 2×2 spatial down-sampling mode would be favored. In this case the thresholds would be large to favor the 2×2 mode. In another example, the motion horizontalness feature may be used to avoid down-sampling along the motion direction, such as by making T₁ larger for strong horizontal motion denoted by Ĉ₄.

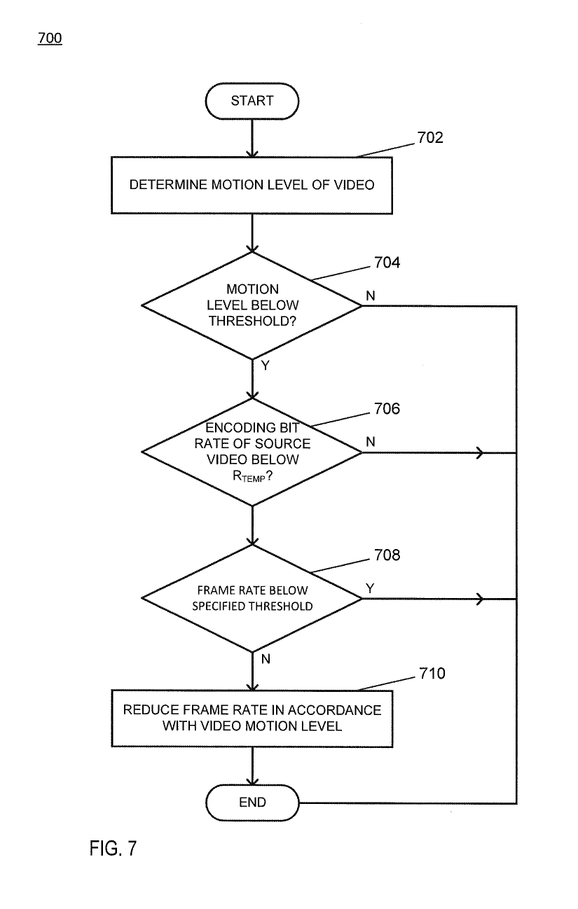

At block 210, a frame rate reduction setting for the video is determined. The visual effects of frame rate reduction may be difficult to capture with objective quality metrics, so it may be appropriate to select a temporal resolution based upon motion characteristics of the video and user preferences. A method for selecting a frame rate is described further below (see FIG. 7).

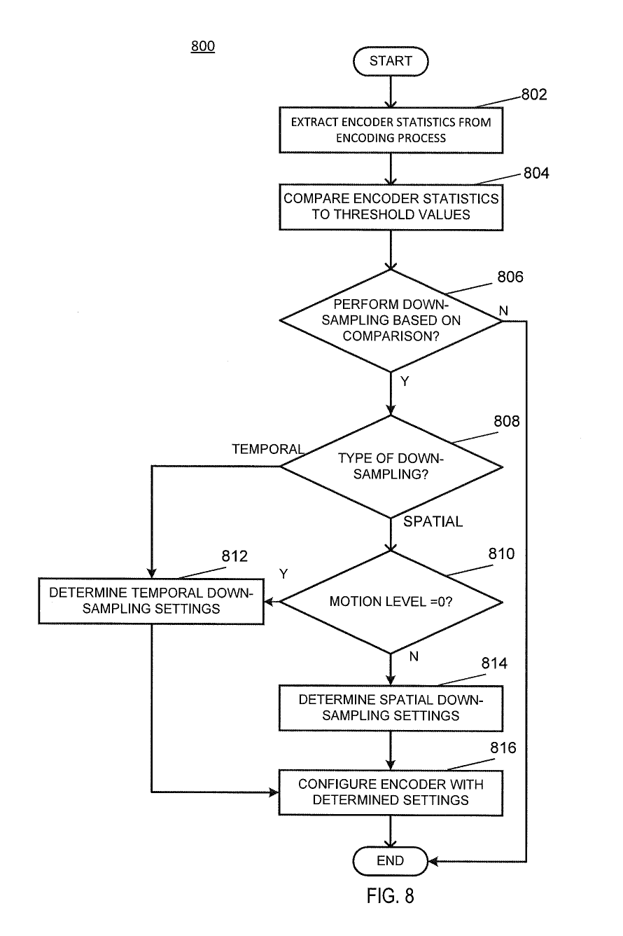

In some aspects, the method 200 may proceed to optional block 214, depending upon whether down-sampling settings were introduced as described above with respect to blocks 206 or 210. This decision is represented by block 212. At block 214, encoder statistics are analyzed to possibly introduce down-sampling settings if no down-sampling decision was made in block 206 or 210. If a down-sampling setting is established from block 214, the method proceeds to block 216 to configure the encoder with the determined settings. Aspects of this process are described further with respect to FIG. 8.

After establishing a spatial and temporal down-sampling rate, the video is then provided to the encoder using the specified parameters at block 216. This block may include down-sampling the video prior to providing it to the encoder.

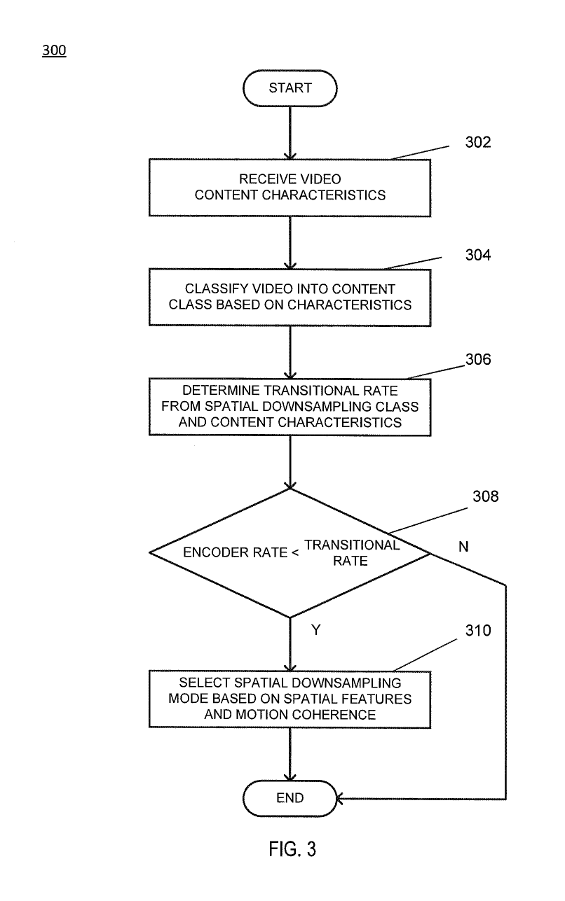

FIG. 3 is a method 300 for determining spatial down-sampling settings based on video content in accordance with aspects of the invention. The method 300 describes a process by which one or more content characteristics of a video are used to select a spatial down-sampling mode. The method 300 may perform the spatial down-sampling determination operations as described above with respect to blocks 206 and 208 of FIG. 2.

At block 302, a set of video content characteristics is received. For example, a set of content characteristics describing a video as sampled by a preprocessor 114 may be received. These content characteristics generally relate to features of the video, such as motion level, motion coherence, motion magnitude, spatial prediction error, and the like. These content characteristics are used to separate the video into one or more content classes, each class associated with threshold values of the content characteristics.

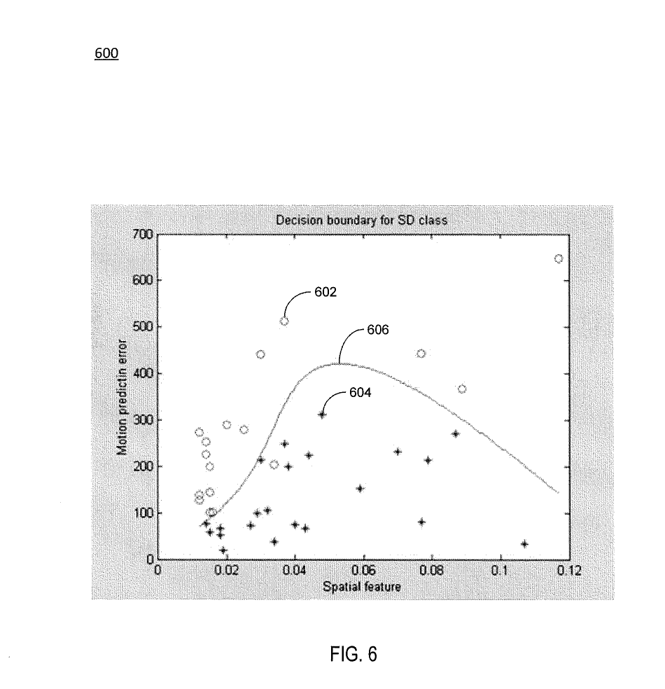

At block 304, the video is placed into a particular content class based on the characteristics as determined at block 302. One content class is the spatial down-sampling class, as described above (see FIG. 2). The spatial down-sampling class is determined by plotting the content characteristics on an n-dimensional plot, and identifying whether the plot for the video falls above or below a decision boundary (see FIG. 6). If the plot for the video falls below the decision boundary, the video is a good candidate for spatial down-sampling.

At block 306, an estimated transitional rate for the video is determined based on the content characteristics. The transitional rate is determined based on a normalized transitional rate, the frame size and frame rate, and content of the source video, as described above (see FIG. 2). In cases where the video is a good candidate for spatial down-sampling, the transitional rate is determined by a representative video sample by minimizing a distortion function based on the content features, and using the representative normalized rate associated with the cluster (see FIG. 2). The normalized rate is then multiplied by the source frame size and the frame rate to identify the estimated transitional rate.

At block 308, the estimated transitional rate is compared to the average encoder rate. If the average encoder rate is less than the estimated transitional rate, then a spatial down-sampling mode is selected at block 310. Otherwise the method 300 ends.

At block 310, a spatial down-sampling mode is selected, such as 2×2, 2×1, or 1×2 down-sampling. As described above, the down-sampling mode selected is dependent upon content characteristics of the video.

After determining the appropriate spatial down-sampling rate, a temporal (frame rate) down-sampling rate may also be determined. In some aspects, the temporal down-sampling rate is determined as with a method described below (see FIG. 7).

FIG. 4 is a method for generating a transitional bit rate lookup table in accordance with aspects of the invention. The transitional bit rate lookup table provides a table of transitional bit rates for a plurality of videos, indexed by content class. The transitional bit rate lookup table is generated by analyzing a plurality of videos to generate a set of peak signal-to-noise (PSNR) ratios and/or structural similarity (SSIM) indices over a variety of spatial down-sampling modes to identify one or more transitional bit rates. The normalized transitional bit rates are then plotted on an n-dimensional plot dependent upon the content characteristics of the individual source video. Clustering algorithms are used to identify clusters of plots. Each cluster is included within a content class as a separate transitional bit rate.

At block 402, content characteristics are extracted from a plurality of videos. The content characteristics may be extracted using a preprocessor in a similar manner as the content characteristics of the source videos are analyzed as described with respect to FIGS. 2 and 3. The extracted content characteristics will be used to classify each of the plurality of videos into a content class.

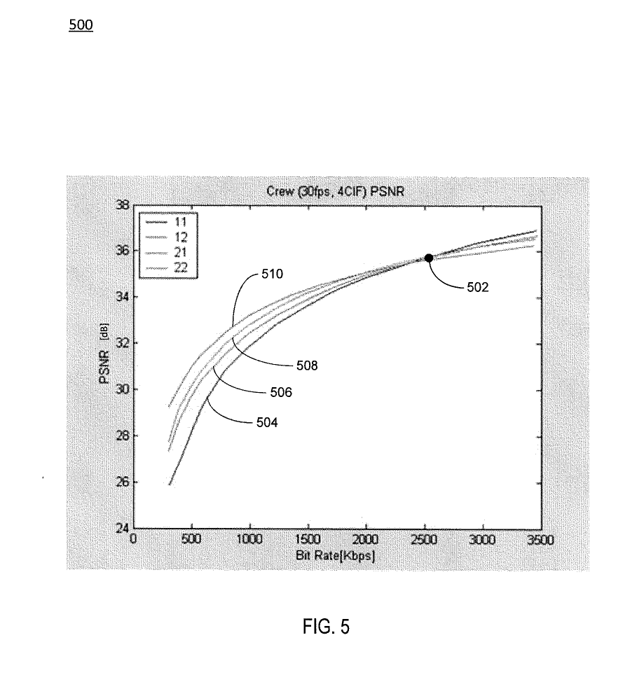

At block 404, SSIM and/or PSNR plots are generated for each of the videos. The plots may include values for the videos at the original spatial resolution, and down-sampled by 2×2, 1×2, and/or 2×1 spatial factor. An exemplary PSNR plot is described below (see FIG. 5).

At block 406, a transitional bit rate for each of the plotted videos is extracted from the plot associated with the video. The transitional bit rate for the video is determined based on the cross-over point observed in the rate curves (see FIG. 5).

At block 408, the extracted transitional bit rate for each video is used to determine if the video is a good candidate for spatial down-sampling. This is achieved by comparing the extracted transitional rate to a threshold value. If the extracted rate is less than the threshold, the video is not a good candidate for spatial down-sampling. In other words, if the bit rate of the video must be reduced below the threshold value to achieve gains by down-sampling, then the video is not a good candidate, as a high transitional bit rate indicates that the video achieves gains from spatial down-sampling. If the transitional bit rate of the video is higher than the threshold value, the video is identified as a good candidate for spatial down-sampling.

At block 410, each video is plotted along an n-dimensional plot, where the n dimensions correspond to a set of relevant content characteristics, such as the content characteristics described with respect to FIG. 2. Each of the plurality of video samples analyzed is placed in this n-dimensional space based on the feature values of the video.

At block 412, a learning algorithm is used to separate the plotted video data into two clusters. The two clusters correspond to videos that are good candidates for spatial down-sampling, and videos that are not good candidates. At block 412, a learning algorithm is used to separate the plotted video data into two clusters. The two clusters correspond to videos that are good candidates for spatial down-sampling, and videos that are not good candidates. The plotted video samples from the database are used as the training set to derive a decision boundary to separate the two clusters in the plot. The video samples are viewed as vectors in n dimensions, and the decision boundary will be a curve in n−1 dimensions. The decision curve will be obtained as a function/model of some subset of the training vectors (video samples). In one aspect, this model for the curve is a linear combination over some subset of training vectors (called the support vectors). The linear combination is parameterized by a set of weights (one for each support vector) and an offset term. The learning algorithm attempts to select the set of support vectors, weight parameters, and offset term, to yield a decision boundary that best separates the data into two clusters. Any type of deterministic or statistical learning algorithm may be applied. In some aspects, the specific learning algorithm to generate the decision boundary a support vector machine (SVM). The SVM model may have the general form:

$$f ( \vec{x} ) = {\sum }_{i ∈ SV} {α}_{i} {y}_{i} K ( \vec{x} , {x}_{i} ) \vec{+} b \qquad ( Eq . 11 )$$

where \vec{x} is an input feature vector (e.g. \vec{x}=(Ĉ₂,Ĉ₆)), and y are the corresponding labels for a given feature vector in the training set (e.g. stars for good spatial down-sampling candidates, circles for not-good candidates). The set of support vectors, \vec{x}εSV, the weight parameters, {αᵢ}, and the bias, b, are obtained from the training process. The standard Gaussian kernel K exp(−v|\vec{x}−\vec{x}ᵢ|²) may be used with 5-fold cross validation for extracting the model parameters. The learning model extracts an n−1 dimensional map/curve to separate the classes. Any type of deterministic or statistical learning may be applied. An illustration of the decision boundary is shown with respect to FIG. 6, for the case of using two features to represent the spatial down-sampling class. In this case the decision boundary is a curve in 1-dim.

In one aspect, the spatial down-sampling class is constructed by using two features, such as the spatial feature and the motion prediction feature, and then applying a SVM model to generate a decision boundary. The SVM generates the map where the magnitude measures the distance from the decision boundary to the analyzed video. The sign of a determinant function ƒ(\vec{x}) yields the spatial down-sampling class state. In one aspect, the feature set used to classify the video is \vec{x}=(Ĉ₆,y), where y is defined from the prediction error of the 2×2, 1×2, 2×1 spatial modes. The value y may equal Ĉ₆, unless Ĉ_{7,8}<TĈ₆, in which case, y=Ĉ_{7,8}. For example, the threshold value T may be set at 0.8, 0.6, or 0.9.

At block 414, clusters of data in the plot with similar normalized transitional rates are identified. For example, thresholds for different values may be determined using K-means clustering over the video samples from the database. Normalized transitional rates for each cluster are determined based on the average SSIM/PSNR cross-over point for the videos in the cluster. Clusters of data within particular content characteristics may also be identified in the same manner to separate the different videos into content classes. For example, a cluster of videos with a motion level 0.5 might establish a content class divider at motion level 0.5, with videos with a greater than 0.5 motion level being placed into motion level class 1, and videos with less than a 0.5 motion level being placed into motion level class 0. Motion class 2 might be defined by a cluster of videos above 1.5 motion level, with motion level 1 defined by the cluster greater than 0.5 and less than 1.5.

At block 416, the calculated transitional rates are stored in a lookup table, indexed by the video content class. The table includes content class information and the normalized transitional rates associated with each class. In some cases, such as for good candidates for spatial down-sampling, the class may be associated with multiple spatial down-sampling rates. Such a lookup table may appear as follows:

TABLE 1

| | Representative |
|---|---|
| | Normalized Transitional |
| State | Rates (bits per pixel [bpp]) |
| SD = 0, Motion = 0 | 0 |
| SD = 0, Motion = 1 | 0.028 |
| SD = 1 | 0.078, 0.18, 0.32 |

where SD is the spatial down-sampling class (SD=1 for a good spatial down-sampling candidate, SD=0 otherwise) and Motion=0/1/2 refers to motion class of type low, medium, and high.

FIG. 5 is a diagram 500 depicting an exemplary transitional bit rate for a sample video in accordance with aspects of the invention. The diagram depicts a plurality of curves plotting PSNR for a sample video as a function of the bit rate of the video. Each curve reflects a different spatial down-sampling rate, with curve 504 corresponding to no spatial down-sampling (1×1), curve 506 corresponding to 1×2 down-sampling, curve 508 corresponding to 2×1 down-sampling, and curve 510 corresponding to 2×2 down-sampling. As the bit rate decreases, so does the PSNR associated with the video, representing an increase in distortion. However, the rate at which the PSNR decreases also increases more slowly for higher rates of spatial down-sampling, to the point where the more down-sampled videos have a higher PSNR compared to the source video with no down-sampling below a certain bit rate. This bit rate is defined by the cross-over point 502, which indicates the transitional bit rate for the sampled video.

FIG. 6 is a diagram 600 depicting a down-sampling decision boundary in accordance with aspects of the invention. The diagram 600 is a plot of a plurality of videos in a database. Each circle 602 and star 604 represents a sample video. The videos are plotted according to a motion prediction error characteristic (y-axis) and a spatial feature prediction error characteristic (x-axis). The stars 604 indicate that a video is not a good candidate for spatial down-sampling. The circles 602 indicate that the video is a good candidate for spatial down-sampling. The boundary line 606 represents a best fit of the division between good candidates for spatial down-sampling and not-good candidates for spatial down-sampling as a function of motion prediction error and spatial features as determined by a SVM. Videos on the plot that lie below this line are generally not a good candidate for spatial down-sampling, while videos above the line are. As such, the decision boundary may be used to identify whether any given sample video is a good candidate for spatial down-sampling by determining on which side of the boundary line the content characteristics of the sample video lie. In aspects where more than two characteristics are analyzed, the plot and boundary line would be present in multiple dimensions.

FIG. 7 is a method 700 for determining frame rate down-sampling in accordance with aspects of the invention. As with spatial down-sampling, content characteristics of the video are used to determine whether the video is a good candidate for temporal down-sampling (frame rate reduction). In particular, the motion level of the video may have a bearing on whether or not temporal down-sampling is appropriate, as videos with higher levels of motion are more susceptible to jerkiness when frames are removed.

At block 702, the motion level class of the video is determined. As described above, the motion level class may be determined by a preprocessor sampling a video prior to encoding. The preprocessor may extract a set of motion values, which place the video into a particular motion class based upon a determined threshold of motion values.

At block 704, if the motion level as determined at block 702 is high (e.g. ML=2 as described above with respect to FIG. 2), then the method 700 ends, as a high motion level is generally indicative that the video is a poor candidate for temporal down-sampling. Otherwise, the method 700 proceeds to block 706.

At block 706, it is determined whether the rate of the video is below a value, Rₜₑₘₚ. Rₜₑₘₚ is based on a transitional rate for the video, such as the transitional rate determined with respect to FIG. 2 or FIG. 3. In some aspects, Rₜₑₘₚ is defined by the function:

Rₜₑₘₚ=αNƒ [symbol] rᵢᵣ [symbol] (Eq. 12)

where α is set to 1 for motion level 0, and 0.5 for motion level 1, N is the input frame size, and f is the input frame rate. The rate [symbol] rᵢᵣ [symbol] is the average normalized transitional rate over all video samples of the SD=1 class within the database. If the rate of the video is below the value of Rₜₑₘₚ, then the method 700 proceeds to block 708. Otherwise, the method 700 ends with no frame rate reduction.

At block 708, a determination is performed as to whether the frame rate of the input video is below a user-specified threshold. This determination allows the user to opt to avoid temporal down-sampling when the video is already below a minimum preferred frame rate. In some aspects, the minimum threshold may be set at 10 frames per second, 30 frames per second, or 60 frames per second. If the frame rate is not already below the minimum threshold, the method 700 proceeds to block 710. Otherwise, the method 700 ends with no frame rate reduction.

At block 710, the video is temporally down-sampled in accordance with the motion level class of the video. This condition is motivated from observations that typically the more motion on the scene, the more distortion and jerkiness is introduced by temporal down-sampling. Consequently, the process in 710 will constrain the temporal down-sampling factor such that the greater the motion level of the source video, the less temporal down-sampling is performed. In some aspects, the frame rate is halved

$$( \frac{f}{2} )$$

where the motion level class is low (e.g. ML=0), and the frame rate is reduced by a third

$$( \frac{2 f}{3} )$$

where the motion level class is medium (e.g. ML=1). After reducing the frame rate in accordance with the motion level, the method ends.

FIG. 8 is a method 800 for performing spatial down-sampling based on encoder statistics in accordance with aspects of the invention. In some aspects of the invention, even if no spatial down-sampling or frame rate reduction was specified for the source video, a resolution change may still be triggered based on some encoder feature statistics, averaged over the time interval T described above. Encoder feature statistics considered may include the percentage of skipped frames, the encoder buffer level, or the percentage of rate mismatch.

At block 802, various encoder feature statistics, such as the percentage of skipped frames, the encoder buffer level, or the percentage of rate mismatch are monitored and extracted. The percentage of skipped frames refers to a ratio of the number of frames skipped by the encoder to the number of frames encoded. The percentage of rate mismatch refers to the average absolute difference between the target and the actual encoding rate, normalized by the target rate. The encoder buffer level refers to the amount of encoded data remaining in the encoder output buffer. The buffer level is updated after encoding of a frame by the amount of data entering the buffer (size of the encoded frame) and the amount of data flowing out of the buffer. The data flowing out is the encoder target rate divided by the encoder frame rate (average per-frame bandwidth).

At block 804, the encoder feature statistics extracted at step 802 are compared to one or more threshold values. Each type of statistic may be compared against a different threshold value. For example, the threshold for percentage of skipped frames may be 20 percent, 30 percent, or 50 percent. The threshold for percentage rate mismatch may be percent, 50 percent, or 75 percent. The threshold for encoder buffer level may be 50 percent, 75 percent, or 80 percent. In the case of skipped frames or percentage rate mismatch, a value greater than the threshold may indicate that either temporal or spatial down-sampling is appropriate (i.e. too many frames are being skipped or the rate mismatch is too great). Also, in the case of encoder buffer level, a value higher than the threshold may indicate that either temporal or spatial down-sampling is appropriate, as a high level of the encoder buffer level may indicate potential buffer overflow, indicating potential underflow at the decoder. Overflow at the encoder is generally the result of internal rate control problems, which may be mitigated by down-sampling the source video before encoding. The results of the comparison of the encoder feature statistics and the threshold value or values are used to determine whether to proceed with spatial or temporal down-sampling.

At block 808, a determination is made as to whether to perform spatial down-sampling or temporal down-sampling. This determination may be made based upon a spatial down-sampling class determined prior to beginning the encoding operation and/or a motion level of the sample.

Where the sample video was determined to be a good candidate for spatial down-sampling, a further determination of a down-sampling method is made at step 810, based on the sample motion level. If the sample is in a low motion class (ML=0), then it is likely that temporal down-sampling will not introduce as much distortion as spatial down-sampling. As such, the method proceeds to block 812 in the event the motion class is equal to 0.

If the motion class is not equal to 0, the method proceeds to block 814 to determine an appropriate spatial down-sampling setting.

At block 814, a down-sampling mode is selected based upon characteristics of the video, such as the prediction error and motion coherence as described with respect to FIG. 3. The decision to employ 2×2, 2×1, 1×2, or the like down-sampling is performed by analyzing the prediction error for each mode and the motion coherence as described above with respect to FIG. 3.

At block 812, if the sample is not a good candidate for spatial down-sampling or the sample has a motion level of 0, the method determines a temporal down-sampling setting. In the case where the sample is not a good candidate for spatial down-sampling, the temporal down-sampling setting may be based upon a motion level of the scene, such as described with respect to FIG. 7. Otherwise, the temporal down-sampling setting may be determined based on user preferences or other threshold values.

At block 816, the video is down-sampled in accordance with the spatial or temporal settings as determined at blocks 812-808. The method 800 then ends.

The stages of the illustrated methods described above are not intended to be limiting. The functionality of the methods may exist in a fewer or greater number of stages than what is shown and, even with the depicted methods, the particular order of events may be different from what is shown in the figures.

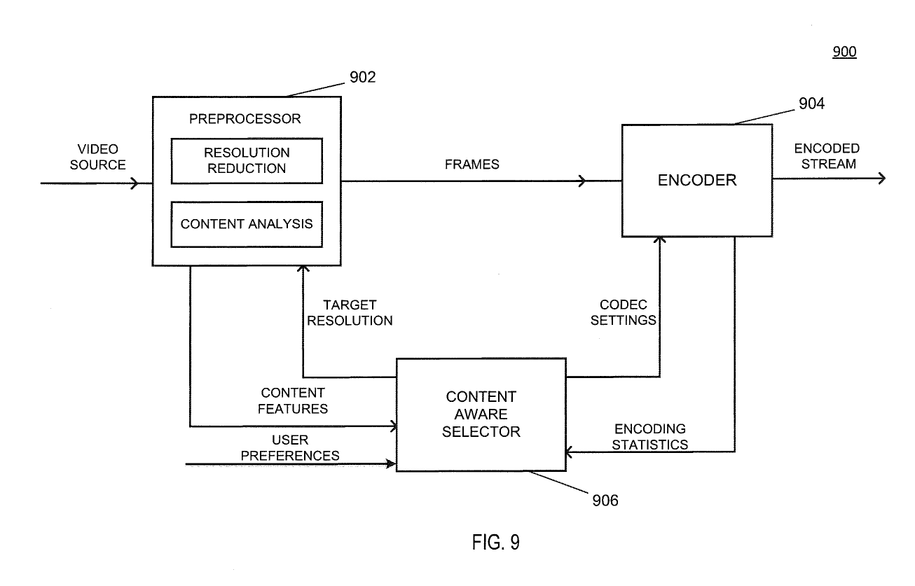

FIG. 9 is a block diagram depicting data flow throughout a system 900 for providing content aware video adaptation in accordance with aspects of the invention. The system 900 includes a preprocessor 902, an encoder 804, and a content aware selector 906. The preprocessor 902 samples a source video for one or more content characteristics, which are transmitted to the content aware selector 906. The content aware selector 906 sets a target spatial resolution and target frame rate for the video and sends the target spatial resolution and frame rate to the preprocessor 902. The preprocessor 902 reduces the spatial and temporal resolution in accordance with the target spatial resolution and frame rate received from the content aware selector 906. The preprocessor 902 provides video frames to the encoder 904. The encoder 904 is configured by the content aware selector with a variety of codec settings, such as the spatial resolution and the frame rate of the video. The encoder 904 also transmits feedback on the encoding statistics to the content aware selector 906 so that the content aware selector 806 may adaptively modify the encoding settings as described above with respect to skipped frames, buffer level, and rate mismatch management (see FIG. 8). The content aware selector manages the frame rate at which the encoder 904 encodes the video. The encoded video is provided as an encoded stream by the encoder 904.

The systems and methods described herein advantageously provide optimized encoding of video. By analyzing the video for one or more content characteristics, and using the content characteristics to map the video to a particular class, the methods and systems determine a transitional bit rate that may be used to properly configure a preprocessor and encoder for optimal encoding of the video. By extracting characteristics using a preprocessor and then mapping the characteristics to a lookup table, aspects of the invention provide for real-time encoding optimization. Methods to generate the lookup table provide a robust and efficient method for classifying source videos and assigning transitional bit rates for use in the lookup table.

As these and other variations and combinations of the features discussed above can be utilized without departing from the invention as defined by the claims, the foregoing description of the embodiments should be taken by way of illustration rather than by way of limitation of the invention as defined by the claims. It will also be understood that the provision of examples of the invention (as well as clauses phrased as “such as,” “e.g.”, “including” and the like) should not be interpreted as limiting the invention to the specific examples; rather, the examples are intended to illustrate only some of many possible embodiments.

1. A computer-implemented method for providing content aware video adaptation, the method comprising:
sampling a source video, using a processor, to extract one or more content characteristics of the source video;
classifying the source video into a content class based upon the extracted content characteristics;
determining a down-sampling setting for the source video based on the content class; and
down-sampling the source video resolution using the determined down-sampling setting to reduce distortion and delay during the encoding process.

2. The method of claim 1, wherein determining a down-sampling setting further comprises:
plotting the extracted content characteristics on an n-dimensional plot, wherein each of n axes of the n-dimensional plot corresponds to a content characteristic; and
identifying the source video as a good candidate for spatial down-sampling based on the relationship of a plot of the extracted content characteristics with a decision boundary.

3. The method of claim 1, wherein further comprising identifying one or more normalized transitional rates using a lookup table indexed by the extracted content characteristics.

4. The method of claim 3, further comprising:
identifying a representative cluster of video samples from video sample database using a distortion function modeled by a weighted distance metric defined over a set of content features between the source video and a video sample from the representative cluster, wherein the video samples used in the distortion function may be conditioned on a content class and an image size; and
selecting one of the plurality of normalized transitional rates by identifying a normalized transitional rate associated with the representative cluster of video samples from a video sample database wherein a distortion function is used to find the representative cluster.

5. The method of claim 1, wherein determining a down-sampling setting further comprises:
determining a transitional rate using the extracted content characteristics; and
determining whether to perform down-sampling based on whether an encoder rate is less than the transitional rate.

6. The method of claim 1, further comprising determining a spatial down-sampling mode, wherein the spatial down-sampling mode is determined by comparing an encoder rate to an identified transitional bit rate multiplied by a threshold.

7. The method of claim 6, further comprising selecting 2×2 down-sampling as the spatial down-sampling mode in response to the encoder rate being less than the identified transitional bit rate multiplied by the threshold.

8. The method of claim 6, further comprising selecting a spatial down-sampling mode based on one or more other content characteristics in response to the encoder rate being greater than or equal to the identified transitional bit rate multiplied by the threshold.

9. The method of claim 8, further comprising selecting 2×2 down-sampling, 1×2 down-sampling, or 2×1 down-sampling depending upon the extracted content characteristics.

10. The method of claim 9, wherein the extracted content characteristics are at least one of a motion coherence or a motion horizontalness.

11. The method of claim 6, wherein one or more user preferences are used to determine whether to perform spatial down-sampling.

12. The method of claim 1, further comprising:
determining the down-sampling setting for the source video based on the content class, wherein the down-sampling setting applies to a temporal down-sampling operation; and
down-sampling the source video frame rate using the determined down-sampling setting such that distortion and delay is minimized during the encoding process.

13. The method of claim 12, further comprising determining the down-sampling setting by a process comprising:
determining a motion level for the source video based on the extracted content characteristics;
computing a temporal down-sampling rate for frame rate reduction based on a frame rate of the source video, a frame size of the source video, a normalized transitional rate associated with the source video, and the motion level;
comparing the temporal down-sampling rate with an encoder rate; and
reducing the frame rate of the source video in response to the encoder rate being less than the temporal down-sampling rate.

14. The method of claim 13, wherein the frame rate of the source video is reduced in accordance with the motion level.

15. The method of claim 13, further comprising comparing the frame rate of the source video with a threshold value, and reducing the frame rate in response to the frame rate being greater than the threshold value.

16. The method of claim 15, wherein the threshold value is a user specified frame rate threshold.

17. The method of claim 1, wherein the content characteristics are extracted at a regular interval.

18. The method of claim 17, wherein the content characteristics are averaged at each interval over a set length of the video.

19. The method of claim 1, wherein the content characteristics associated with the video are at least one of a size of zero motion value, a motion prediction error value, a motion magnitude value, a motion horizontalness value, a motion distortion value, a normalized temporal difference value, and one or more spatial prediction errors associated with at least one spatial down-sampling mode.

20. The method of claim 1, further comprising:
tracking one or more encoder statistics; and
down-sampling at least one of the spatial resolution or the temporal resolution of the source video in response to the encoder statistics dropping below a threshold value.

21. The method of claim 20, wherein the encoder statistics are at least one of a percentage of skipped frames, a percentage rate mismatch, or an encoder buffer level.

22. The method of claim 20, further comprising selecting at least one of a spatial down-sampling mode or a temporal down-sampling mode in accordance with the content characteristics of the source video.

23. A computer-implemented method for identifying video candidates for spatial down-sampling, the method comprising:
extracting, using a processor, one or more content characteristics from a plurality of videos;
generating a video quality metric plot for each of the plurality of videos by plotting a distortion metric as a function of a video bit rate, the video quality metric plot comprising plotted distortion metrics for each video with a plurality of spatial down-sampling modes;
extracting a transitional bit rate from the video quality metric plot for each of the plurality of videos;
determining whether the extracted transitional bit rate for each video of the plurality of videos is greater than a threshold bit rate;
generating an n-dimensional plot for the plurality of videos, the n-dimensional plot comprising n axes corresponding to content characteristics of the videos, with each video plotted in accordance with its associated extracted content characteristics; and
computing a decision boundary between a set of videos with extracted transitional bit rates greater than the threshold bit rate and a set of videos with extracted transitional bit rates less than the threshold bit rate.

24. The method of claim 23, further comprising:
identifying one or more clusters of data points corresponding to videos with similar content characteristics; and
storing the clusters within a data table indexed by the content characteristics.

25. The method of claim 24, wherein the data table further comprises one or more normalized transitional rates associated with the clusters.

26. The method of claim 23, wherein the distortion metric is a peak signal-to-noise ratio (PSNR) or structural similarity (SSIM) metric.

27. The method of claim 23, wherein the decision boundary is an n−1 dimensional curve derived from a support vector machine trained on the content characteristics and spatial down-sampling candidacy of the plurality of videos.

28. The method of claim 23, wherein the n-dimensional plot is a 2 dimensional plot with axes corresponding to a motion prediction error value and a spatial prediction error value.

29. A processing system for providing content aware media adaptation comprising:
at least one processor;
a preprocessor for sampling a source video and extracting one or more content characteristics;
a content aware selector associated with the at least one processor and the preprocessor; and
memory for storing a video database, the memory coupled to the at least one processor;
wherein the preprocessor samples a source video to extract one or more content characteristics of the source video; and
wherein the content aware selector classifies the source video into a content class based on the content characteristics, determines a spatial down-sampling setting for the video, determines a temporal down-sampling setting for the video, and configures an encoder to encode the video in accordance with the spatial down-sampling setting and the temporal down-sampling setting.

30. The processing system of claim 29, further comprising an encoder module to encode the source video in accordance with one or more settings received from the content aware selector.

31. The processing system of claim 29, wherein the content aware selector further performs a lookup operation on the database to classify the source video.

32. The processing system of claim 31, the database is indexed by one or more content characteristics, and wherein the lookup operation provides a normalized transitional bit rate for the source video.
